(19) United States
(12) Patent Application Publication
(10) Pub. No.: US 2009/0085849 A1
(43) Pub. Date: Apr. 2, 2009

(54) Fast Overdriving Method of LCD Panel

(76) Inventors: Te-Chen Chung, Kunshan (CN); Tean-Sen Jen, Kunshan (CN); Junrui Zhang, Kunshan (CN)

Correspondence Address: Nixon Peabody LLP, 200 Page Mill Road, Suite 200, Palo Alto, CA, 94306, US

(21) Appl. No.: 12/202,336

(22) Filed: Sep. 1, 2008

(30) Foreign Application Priority Data
Sep. 29, 2007 (CN) 200710161385.X

(51) Int. Cl. G09G 3/36

(52) U.S. Cl. 345/89

(57) ABSTRACT

A driving method for a liquid crystal display (LCD) panel is provided. The method comprises applying corresponding overdriving data for source data to the LCD panel at the beginning of a frame; applying black data to the LCD panel before the end of the frame, wherein the polarities of the applied black data are the same as the pixel electrode driving polarity at the beginning of a next frame; and applying the source data to the LCD panel at a time between the application of the overdriving data and the application of the black data. The driving method of the invention eliminates the need for large TFTs by reducing the voltage change between the end of a previous frame and the beginning of a current frame, and also can perform pre-charging for the pixel electrodes without adding any other device.

### FIELD OF THE INVENTION

The invention relates to a liquid crystal display (LCD), and in particular, to a driving method for a LCD panel.

### BACKGROUND

A LCD generally makes use of characteristics of liquid crystal molecules to display images. LCDs have many advantages such as thinness, light weight, low driving voltage, low power consumption and the like. Therefore, LCDs are widely utilized in various fields.

LCDs display images by adjusting light transmission rate of liquid crystal molecules. An LCD comprises an LCD panel and a driving circuit adapted to drive the LCD panel. The LCD panel includes a plurality of pixels arranged in a matrix form.

The LCD panel comprises an upper substrate, a lower substrate and liquid crystal molecules interposed therebetween. The LCD panel comprises m data lines and n scanning lines, the n scanning lines being substantially vertical to the m data lines so as to define m×n pixels. Each pixel comprises a thin film transistor (TFT) operating as a switch. The TFT comprises a gate electrode that is electrically connected to one of the plurality of scanning lines, a source electrode that is electrically connected to one of the plurality of data lines and a drain electrode that is electrically connected to a pixel electrode. When the TFT is turned on in response to a scanning pulse applied from the scanning line to the gate electrode, a pixel voltage applied to the data line is transmitted to the pixel electrode via the TFT.

The driving circuit comprises a timing control section, a scan driving section and a data driving section. The scan driving section generates scanning pulses and sequentially applies these scanning pulses to the corresponding scanning lines under the control of the timing control section. The data driving section transforms image signals into pixel voltages, and applies the pixel voltages to the data lines under the control of the timing control section.

In some cases, conventional LCDs cannot display a desirable color and luminance. When displaying moving images, the display luminance cannot reach a target luminance corresponding to the changed level of video data because of a long response time. Consequently, a phenomenon of motion illegibility occurs in the moving images and the display quality of the LCD deteriorates due to the decrease of contrast.

Several solutions have been proposed in order to address the above problem. One technique is the Black Frame Insertion Technology (referred to as Black Insertion hereinafter), which periodically inserts a complete black frame between two frames by using an IC control chip, so as to avoid the appearance of blurring during the switching of frames and thus eliminating the phenomenon of image sticking. Another technique is Over Drive (referred to as OD hereinafter), which reduces the time spent by the grayscale transforming process by increasing stimulating voltages in the grayscale transform. Below, a conventional OD technique is described with reference to FIG. 1a. Generally, the driving frequency is 120 Hz. When a pixel is transformed from a low grayscale value to a high grayscale value (referred to as OD grayscale), a voltage (referred to as OD voltage hereinafter) for a higher grayscale, is applied to the pixel of the LCD panel; when a pixel is transformed from a high grayscale to a low grayscale, a voltage for a lower grayscale, is applied to the pixel of the LCD panel.

FIG. 1b is a schematic diagram of a lookup table for the driving method illustrated in FIG. 1a. Any OD grayscale desired for transforming from a current grayscale to a target grayscale may be looked up the lookup table. For example, when switching from the Nth frame to the (N+1)th frame, it is desirable to look up in accordance with the grayscale data for the (N+1)th frame (i.e. output grayscale) and the grayscale data for the Nth frame (i.e. input grayscale) in the lookup table. In a typical OD technique, since the grayscale of the Nth frame is possible to be any grayscale, the varieties of input grayscales are of a large number. Suppose that the current grayscale L192 for the Nth frame is to be transformed to the target grayscale L32 for the (N+1)th frame, it is necessary to first charge an OD voltage corresponding to an overdrive grayscale L20 (which can be obtained from the lookup table illustrated in FIG. 1b) for a target grayscale L32, then charge a voltage corresponding to the target grayscale L32 after a period of ¼ frame, and then charge an OD voltage corresponding to an overdrive grayscale L248 (which can be obtained from the lookup table illustrated in FIG. 1b) for a next target grayscale L128 after a period of ¾ frame. That is, the charging interval between the target data and the overdrive data for the target data is the period of ¼ frame, and the charging interval between the target data and the overdrive data for the next target data is the period of ¾ frame.

Thus, the above driving method needs two periods for charging, wherein one is to charge the OD voltage and the other is to charge the source data voltage. At the beginning of a frame, the charging voltage changes from the source data voltage applied in the previous frame to the OD voltage required for the current frame directly. However, there is often a relatively large voltage difference between the source data voltage applied in the previous frame and the OD voltage in the current frame, especially when the pixel driving polarity of the current frame is the opposite to that of the previous frame, which is very often the case in today's LCDs. Therefore, a thin film transistor of large size typically has to be provided to satisfy the charging demand. However, a large thin film transistor results in a larger parasitical capacitance and a high RC delay, and then the aperture ratio must be sacrificed to some extent in order to shield the TFT. Moreover, a typical overdriving technique needs to obtain overdrive data by searching a relatively complex lookup table, and thus needs a memory with large capacity and high manufacturing cost.

### SUMMARY OF THE INVENTION

According to an embodiment of the invention, a driving method for a liquid crystal display panel is provided. The method comprises: applying corresponding overdriving data for source data to the liquid crystal display panel at the beginning of a frame; applying black data to the liquid crystal display panel at the end of the frame, wherein the polarities of the applied black data are the same as the pixel electrode driving polarity at the beginning of the next frame; and applying the source data to the liquid crystal display panel at a time between the application of the overdriving data and the application of the black data.

According to another embodiment of the invention, the driving method for a liquid crystal display panel can be applied to a liquid crystal display panel in which a single data line is connected to pixel electrodes having the same polarities.

According to another embodiment of the invention, the liquid crystal display panel can comprise a plurality of regions from the top to bottom, and the black data is applied to the pixels of each region simultaneously before the end of a frame.

According to embodiments of the invention, the voltage change between the end of a previous frame and the beginning of a current frame can be reduced, thereby decreasing the RC loading so that the size of thin film transistors can be small and the aperture ratio is larger, reducing the Motion Picture Response Time (MPRT) and realizing pre-charge function of pixels without additional devices. In addition, a simpler lookup table for overdrive data can be generated by using black data as input and thus saving storage space. Furthermore, the power consumption for driving the liquid crystal display panel can be further decreased by charging all the black data to the pixels of a corresponding region simultaneously.

### BRIEF DESCRIPTION OF THE DRAWINGS

From the following detailed description to the embodiments, accompanying with the drawings, the present invention will be more apparent. In the drawings,

FIG. 1a is a schematic diagram illustrating a conventional overdriving method;

FIG. 1b is a schematic diagram illustrating a lookup table for the overdriving method of FIG. 1a;

FIG. 2 is a schematic diagram illustrating a Dot Inversion driving type of a conventional liquid crystal display panel (herein simply referred to as “Z-type liquid crystal display panel”);

FIG. 3 is a flow chart illustrating a driving method in accordance with an embodiment the invention;

FIG. 4 is a schematic diagram illustrating the course of data application in the driving method in accordance with an embodiment of the invention;

FIG. 5a is a schematic diagram illustrating the pixel driving polarities at the beginning of the Nth frame in a Z-type liquid crystal display panel;

FIG. 5b is a schematic diagram illustrating the pixel driving polarities before the ending of the Nth frame in a Z-type liquid crystal display panel;

FIG. 5c is a schematic diagram illustrating the pixel driving polarities at the beginning of the (N+1)th frame in a Z-type liquid crystal display panel;

FIG. 6 is a schematic diagram illustrating charging for a pixel electrode in accordance with an embodiment of the invention; and

FIG. 7 is a schematic diagram illustrating a lookup table used in the technique for driving a liquid crystal display panel in accordance with an embodiment of the invention.

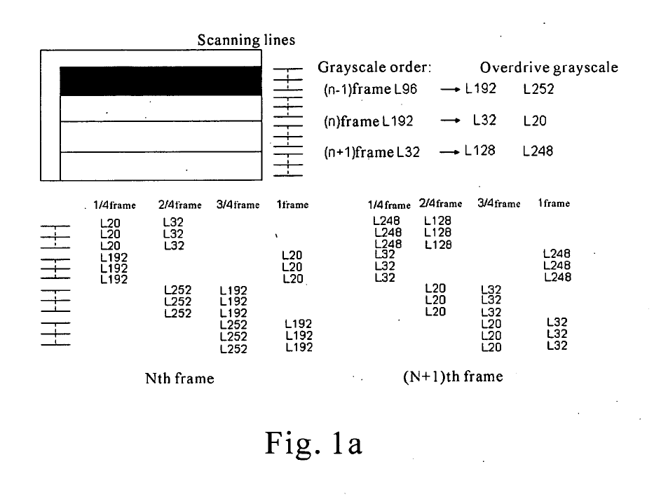

### DETAILED DESCRIPTION OF EMBODIMENTS

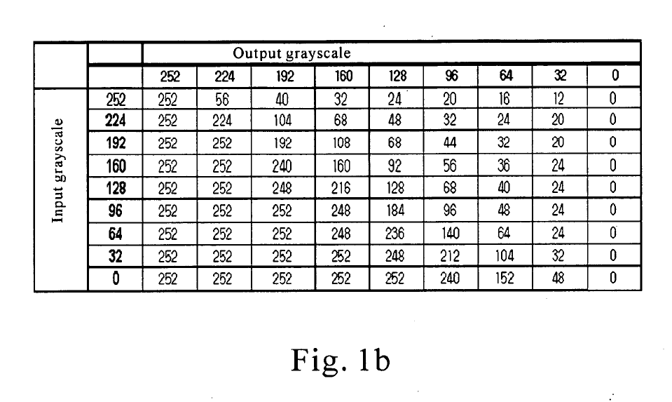

Embodiments of the invention include an overdriving method in a liquid crystal display panel of a liquid crystal display. Now, an embodiment of the invention will be illustrated with reference to FIGS. 2-7. The objects and features of the invention will be more clarified by the drawings and following description.

Most of the conventional liquid crystal display panels utilize the Dot Inversion driving method in order to improve the quality of display frames. When the overdrive method of the invention is applied to a Dot Inversion type liquid crystal display panel illustrated in FIG. 2, a driving effect better than the expected driving effect can be achieved (e.g., the power consumption can be further decreased). Therefore, the overdriving method of the invention will be described by taking such Dot Inversion type liquid crystal display panel (hereinafter referred to as “Z-type liquid crystal display panel”) as an example. However, it is noted that the driving method of the invention is not limited to the Z-type liquid crystal display panel, but is widely applicable to other various liquid crystal display panels.

The detailed description on the Z-type liquid crystal display is discussed in more detail in Chinese patent application No. 200480041818.2. In short, a Z-type liquid crystal display panel comprises n scanning lines GL1, GL2, . . . GLn, m+1 data lines DL1, DL2, . . . DLm+1 and m×n pixels, where “m” and “n” denote integers equal to or greater than 1. Each pixel 110 includes a switching component 112 and a pixel electrode 114. The switching component 112 corresponds to a thin film transistor (TFT). The TFT includes a gate electrode connected to one of the scanning lines GL1, GL2, . . . GLn and a source electrode connected to one of the data lines DL1, DL2, . . . DLm+1. Consequently, the switching components 112 turn on in response to the scanning pulses provided via the scanning lines GL1, GL2, GLn, so as to supply pixel voltages provided via the data lines DL1, DL2, DLm+1 to the pixel electrodes 114.

In the case of Dot Inversion driving, all the switching components 112 electrically connected to odd-numbered data lines DL1, DL3, DL5, . . . are electrically connected to the pixels of positive polarity; conversely, all the switching components 112 electrically connected to even-numbered data lines DL2, DL4, DL6, . . . are electrically connected to the pixels of negative polarity. As a result, all the pixels connected to a single data line have the same driving polarity.

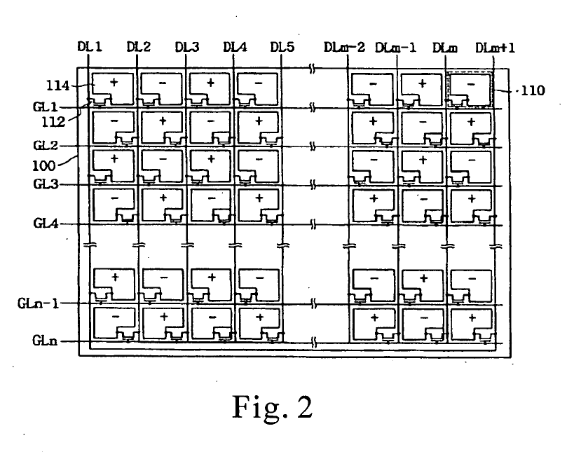

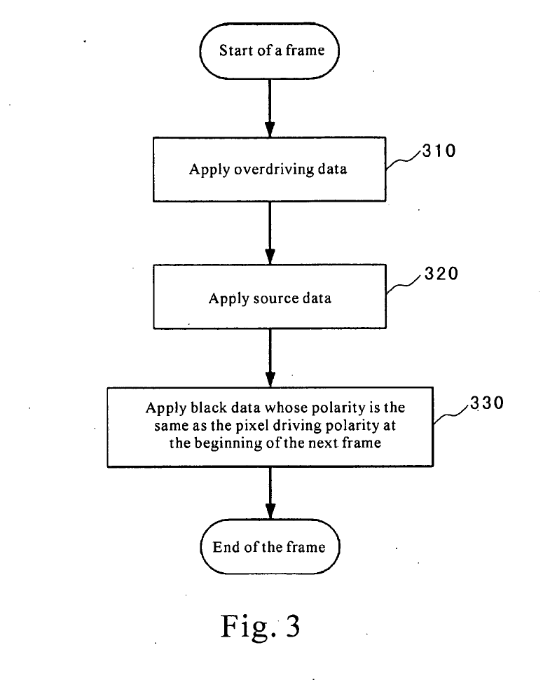

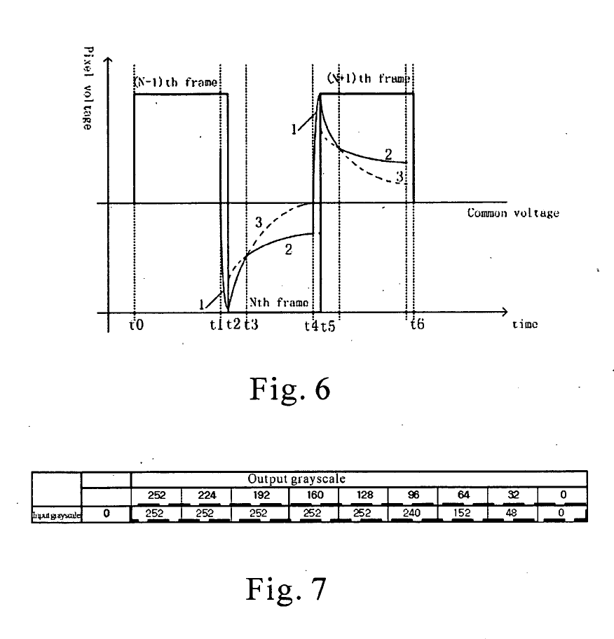

FIG. 3 and FIG. 4 are a flow chart illustrating a driving method and a schematic diagram illustrating the data application in accordance with an embodiment of the invention, respectively. As illustrated in FIG. 3, in the case of driving at a frequency of 120 Hz, during one frame, overdriving data, source data and black data are charged to the liquid crystal display panel in turn at 310, 320 and 330. The process of data application in accordance with an embodiment of the invention will be described in further detail below in conjunction with to FIG. 4. Please note that the process of data application as illustrated herein is the process of data application for the Z-type liquid crystal display panel illustrated in FIG. 2, and in the following description, the grayscale data applied for obtaining a certain grayscale is denoted directly by the grayscale. For example, when a pixel is transformed from the grayscale L0 to the grayscale L32 during the (N−1)th frame, an overdrive grayscale that corresponds to such transforming is L48 (referring to the lookup table illustrated in FIG. 7, in which the input grayscales of all the transforms are L0); when the pixel is transformed from the grayscale L32 to the grayscale L64 is performed during the Nth frame, an overdrive grayscale that corresponds to such transforming is L152; when the pixel is transformed from the grayscale L64 to the grayscale L96 during the (N+1)th frame, an overdrive grayscale that corresponds to such transform is L240.

A frame can also be divided into five regions, each of which corresponds to a group comprising three scanning lines. It is noted that only three scanning lines are illustrated in FIG. 4 for clarity, and that each group actually comprises many scanning lines, which are applied with scanning signals in turn so as to allow grayscale data coming from the data lines to be written to the pixels. For example, in the Nth frame during the period of the first ⅕ frame of the Nth frame, the first and second groups of multiple scanning lines are applied with scanning signals in turn and the grayscale data L152 and L32 are respectively written into the corresponding pixels, while the third group of multiple scanning lines are simultaneously applied with scanning signals and the black data L0 are written into the corresponding pixels at one time. Thereafter, the pixels controlled by the first group of many scanning lines are charged with the source data L64 in turn during the period of the second ⅕ frame of the Nth frame, and then after the period of ⅗ frame, these pixels are charged with the black data L0 simultaneously before the end of the Nth frame; the pixels controlled by the second group of multiple scanning lines are charged with the black data L0 simultaneously after the period of ⅗ frame, and during the period of the subsequent ⅕ frame, these pixels are charged with the OD data L152 for the target source data L64; the pixels controlled by the third group of multiple scanning lines are charged with the OD data L48 for the target source data L32 in turn during the period of the second ⅕ frame, and then charged with the target source data L32 in turn during the period of the next ⅕ frame. The cases of the fourth and fifth groups are similar to that of the third group, so the related description is omitted. In a similar manner, the pixel is transformed from the grayscale data L64 to L96 during the period of the (N+1)th frame. Because the black data L0, the charging times of which are negligible as compared with the charging times of other data including the OD data and the source data, are charged into pixels simultaneously with respect to each group, the required driving frequency can be regarded as 120 Hz instead of 180 Hz although 3 periods of charging are required for each frame, and the power consumption is not increased. Since the scanning for the liquid crystal display panel is conducted from the top to bottom, the data updated for the lower pixels are always later than those for the upper pixels. As can be seen from the above description, during the period of a frame, the OD voltages are first charged into the liquid crystal display panel, the source data voltages are charged into the liquid crystal display panel after the period of ⅕ frame, and then the black data are charged into the liquid crystal display panel after the period of the next ⅗ frame. That is to say, whenever the target source data are being charged, the black data L0 are taken as starting points to initiate the charge to overdriving data. Please note that the target source data as mentioned herein corresponds to the source data of the invention. In addition, although in the present embodiment, the liquid crystal display panel is divided into five regions from the top to bottom, those of ordinary skill in the art will understand that such division is only a one possible division, and other divisions are possible. The number of divisions is not limited to only 5 division. There may be fewer or additional divisions.

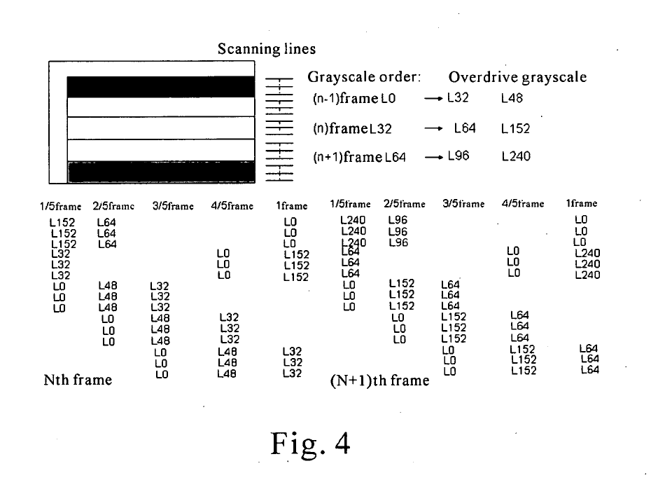

FIGS. 5a, 5b and 5c are schematic diagrams illustrating the pixel driving polarities of the Z-type liquid crystal display panel in accordance with an embodiment of the invention. FIG. 5a illustrates the driving polarities of individual pixels under the Dot Inversion driving in the Nth frame. In this Z-type liquid crystal display panel, a single data line is connected to the pixel electrodes with same driving polarities in two adjacent columns. FIG. 5b illustrates the pixel driving polarities when the black data are charged into the pixels before the end of the Nth frame. FIG. 5c illustrates the pixel driving polarities of the individual pixels under the Dot Inversion driving in the (N+1)th frame. Likewise, before the end of the (N+1)th frame, the black data are charged into the pixels to arrive at the next frame (not shown in the figure). As can be seen, the driving polarities illustrated in FIG. 5b is the same as that in FIG. 5c, that is, the polarities of the black data applied before the end of the Nth frame is the same as the pixel driving polarity at the beginning of the (N+1)th frame. Since the driving polarities of the pixel electrodes connected to a single data line are the same, such changes of polarities are easy to implement.

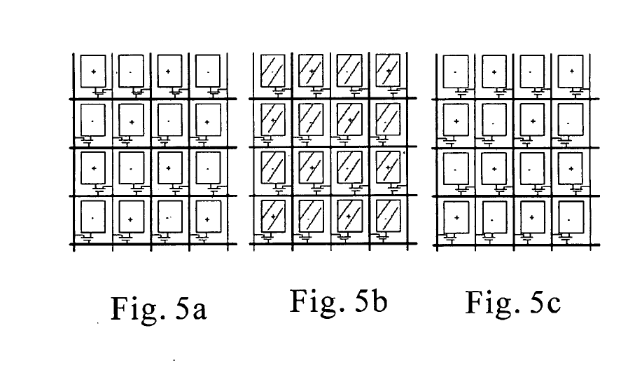

The following is a description for the charging of a pixel electrode in accordance with an embodiment of the invention with reference to FIG. 6, where the reference numerals 1, 2 and 3 respectively indicate the charging lines when the black data, the source data and the overdrive data are applied, respectively. In the figure, solid curves represent the real charging procedure while dashed lines represent the would-be charging procedures if the source data or the overdrive data were applied, respectively. As illustrated by the line 1 in FIG. 6, the period of the (N−1)th frame is from t0 to t2, the Nth frame is from t2 to t5, and the (N+1)th frame is from t5 to t6. For example, the pixel driving polarity of the (N−1)th frame is positive, the pixel driving polarity of the Nth frame is negative, and the pixel driving polarity of the (N+1)th frame is positive. For example, the transforming from the (N−1)th frame to the Nth frame, at the time t1 of the end of the (N−1)th frame, the black data with negative polarities are charged into the pixel electrodes whose original driving polarities are positive, and thus the polarities of the pixel electrodes become negative. Then, at the beginning of the Nth frame, the overdrive data are charged into the pixel electrodes during the period from t2 to t3, and next the source data are charged into the pixel electrodes during the period from t3 to t4. Likewise, during the transforming from the Nth frame to the (N+1)th frame, the black data having positive polarities is charged into the pixel electrodes within the period from t4 to t5 before the end of the Nth frame. As can be seen from FIG. 6, the pixels charging at the Nth frame begins at the ending points of the charging of the black data applied at the (N−1)th frame. Therefore, the black insertion herein not only avoids the blurring that occurs at the edges when the frames are switched and thus eliminates the phenomenon of image sticking, but also provides an operation of pre-charging prior to the data of the (N+1)th frame being charged into pixel electrodes. However, if the charged black data have the same polarities as the pixels of the Nth frame, the above-mentioned precharging effect cannot be achieved.

The driving method of an embodiment of the invention has been described above by the example of the Z-type liquid crystal display panel, however, those of ordinary skill in the art will appreciate that the driving method of the invention is not only limited to Z-type liquid crystal display panels. For example, in the case of a liquid crystal display panel using Column Inversion driving which also has the feature that a single data line is connected to the pixel electrodes having same driving polarities, similar functionality as described in the above embodiment can also be implemented. In addition, in the cases of other liquid crystal display panels not having the above feature, such as liquid crystal display panels using Frame Inversion driving, liquid crystal display panels using Row Inversion driving and other types of liquid crystal display panels by Dot Inversion driving, the driving method of the invention can also be used, except that the black data cannot be charged simultaneously.

FIG. 7 illustrates a lookup table used in the OD technique for the liquid crystal display according to an embodiment of the invention. Since each frame is ended by black data, the input grayscale in the lookup table is only the black data L0. Instead of the conventional lookup table, the driving method of the invention employs the lookup table illustrated in FIG. 7, so that the content of the lookup table stored in a RAM storage can be greatly reduced and thus the storage space can be saved.

The above is a detailed description to the overdrive method for the liquid crystal display panel. Although embodiments have been described to illustrate the principles and implementation of the invention, the description is only for purpose of explanation of the spirits and ideas of the invention and not to limit the scope of the invention. Meanwhile, various modifications and alternatives to the above embodiment within the scope of the invention are apparent for those of ordinary skill in the art, as long as such modifications and alternatives fall into the scope as defined by the appended claims and the equivalents thereof.

What is claimed is:

1. A driving method for a liquid crystal display panel, comprising:
applying corresponding overdriving data for source data to the liquid crystal display panel at the beginning of a frame;
applying black data to the liquid crystal display panel before the end of the frame, wherein the polarities of the applied black data are the same as the pixel electrode driving polarity at the beginning of a next frame; and
applying the source data to the liquid crystal display panel at a time between the application of the overdriving data and the application of the black data.

2. The driving method for a liquid crystal display panel according to claim 1, wherein a single data line in the liquid crystal display panel is connected to pixel electrodes having the same driving polarities.

3. The driving method for a liquid crystal display panel according to claim 2, wherein the liquid crystal display panel comprises a plurality of regions from top to bottom, and the applying black data to the liquid crystal display panel before the end of the frame comprises applying the black data simultaneously to the pixels of each region before the end of the frame.

4. The driving method for a liquid crystal display panel according to claim 3, wherein the plurality of regions are five regions.

5. The driving method for a liquid crystal display panel according to claim 1, wherein the applying corresponding overdriving data for source data to the liquid crystal display panel at the beginning of the frame comprises: applying the overdriving data to the liquid crystal display panel for ⅕ of the period of the frame before the source data are applied.

6. The driving method for a liquid crystal display panel according to claim 5, wherein the applying black data to the liquid crystal display panel before the end of the frame comprises: applying the black data to the liquid crystal display panel during the ⅕ of the period of the frame before the end of the frame.

7. The driving method for a liquid crystal display panel according to claim 1, wherein a lookup table for the overdriving data is established by using the black data as input.

8. The driving method for a liquid crystal display panel according to claim 1, wherein a period of time in which the source data are applied to the liquid crystal display panel is longer than a period of time in which the overdriving data are applied to the liquid crystal display panel.

9. The driving method for a liquid crystal display panel according to claim 2, wherein a period of time in which the source data are applied to the liquid crystal display panel is longer than a period of time in which the overdriving data are applied to the liquid crystal display panel.

10. The driving method for a liquid crystal display panel according to claim 3, wherein a period of time in which the source data are applied to the liquid crystal display panel is longer than a period of time in which the overdriving data are applied to the liquid crystal display panel.

11. The driving method for a liquid crystal display panel according to claim 4, wherein a period of time in which the source data are applied to the liquid crystal display panel is longer than a period of time in which the overdriving data are applied to the liquid crystal display panel.

12. The driving method for a liquid crystal display panel according to claim 5, wherein a period of time in which the source data are applied to the liquid crystal display panel is longer than a period of time in which the overdriving data are applied to the liquid crystal display panel.

13. The driving method for a liquid crystal display panel according to claim 1, wherein the driving frequency of the liquid crystal display panel is 120 Hz.

14. A driving method for a liquid crystal display device, the liquid crystal display device comprising a liquid crystal display panel and a driving circuit adapted to drive the liquid crystal display panel, the driving method comprising:
applying overdriving data for source data to the liquid crystal display panel at the beginning of a frame;
applying black data to the liquid crystal display panel before the end of the frame, wherein the polarities of the applied black data are the same as the pixel electrode driving polarity at the beginning of a next frame; and
applying the source data to the liquid crystal display panel at a time between the application of the overdriving data and the application of the black data.

15. The driving method for a liquid crystal display device according to claim 14, wherein a single data line in the liquid crystal display panel is connected to pixel electrodes having the same driving polarities.

16. The driving method for a liquid crystal display device according to claim 15, wherein the liquid crystal display panel comprises a plurality of regions from top to bottom, and the applying black data to the liquid crystal display panel before the end of the frame comprises applying the black data simultaneously to the pixels of each region before the end of the frame.

17. The driving method for a liquid crystal display device according to claim 14, wherein the applying corresponding overdriving data for source data to the liquid crystal display panel at the beginning of the frame comprises: applying the overdriving data to the liquid crystal display panel for ⅕ of the period of the frame before the source data is applied.

18. The driving method for a liquid crystal display device according to claim 17, wherein the applying black data to the liquid crystal display panel before the end of the frame comprises: applying the black data to the liquid crystal display panel during the ⅕ of the period of the frame before the end of the frame.

19. The driving method for a liquid crystal display device according to claim 14, wherein a period of time in which the source data are applied to the liquid crystal display panel is longer than a period of time in which the overdriving data are applied to the liquid crystal display panel.
